(19) United States
(12) Patent Application Publication
(10) Pub. No.: US 2014/0217322 A1
(43) Pub. Date: Aug. 7, 2014

(54) LITHIUM ION CAPACITOR

(71) Applicants: Kinji Yamada, Tsukuba-shi (JP); Ho-Jin Lee, Yokkaichi-shi (JP); Toshimitsu Kikuchi, Tsukuba-shi (JP); Taisuke Kasahara, Yokohama City (JP); Hiromoto Katsuyama, Mishima-gun (JP)

(72) Inventors: Kinji Yamada, Tsukuba-shi (JP); Ho-Jin Lee, Yokkaichi-shi (JP); Toshimitsu Kikuchi, Tsukuba-shi (JP); Taisuke Kasahara, Yokohama City (JP); Hiromoto Katsuyama, Mishima-gun (JP)

(73) Assignee: JSR CORPORATION, Minato-ku, Tokyo (JP)

(21) Appl. No.: 13/983,428

(22) PCT Filed: Jan. 17, 2012
(86) PCT No.: PCT/JP2012/050776

§ 371 Date: Oct. 9, 2013

(30) Foreign Application Priority Data
Feb. 3, 2011 (JP) 2011-021513

(51) Int. Cl. H01G 11/56

(52) U.S. Cl. CPC H01G 11/56
USPC 252/62.2

(57) ABSTRACT

A lithium-ion capacitor includes a non-aqueous electrolyte solution that includes (A) a compound represented by the following general formula (1), (B) a cyclic carbonate ester that includes at least one carbon-carbon unsaturated bond, and (C) a carboxylic ester, the non-aqueous electrolyte solution having a ratio (M_{B}/M_{C}) of 0.001 to 0.5, the ratio (M_{B}/M_{C}) being the ratio of the content (M_{B}) (mmol/g) of the cyclic carbonate ester (B) to the content (M_{C}) (mmol/g) of the carboxylic ester (C).

Z⁺.[X(CN)ₘ(Y)ₙ]⁻ (1)

wherein X is at least one element selected from boron, aluminum, silicon, phosphorus, and arsenic, Y is a halogen, Z is lithium or magnesium, m is an integer from 3 to 6, and n is an integer from 0 to 5, provided that m+n≧3.

### TECHNICAL FIELD

The present invention relates to a lithium-ion capacitor.

### BACKGROUND ART

In recent years, a high-voltage electrical storage device having a high energy density has been desired as a power supply for driving an electronic instrument. In particular, a lithium-ion capacitor has been expected to be a high-voltage electrical storage device having a high energy density. In order to obtain a lithium-ion capacitor that exhibits excellent charge-discharge characteristics, it is indispensable to improve the characteristics of the electrolyte solution that allows movement of lithium ions in addition to improving the characteristics of the cathode or the anode.

A non-aqueous electrolyte solution prepared by dissolving a lithium salt (e.g., lithium hexafluorophosphate (LiPF₆)) in a non-aqueous solvent such as a cyclic carbonate ester (e.g., ethylene carbonate), a chain-like carbonate ester (e.g., dimethyl carbonate), or a carboxylic ester (e.g., gamma-butyrolactone) has been normally used as the electrolyte solution. For example, JP-A-11-97062 discloses that a lactone compound (i.e., carboxylic ester) can provide sufficient conductivity even at a low temperature due to a low freezing point and a high dielectric constant.

However, since a carboxylic ester is easily reduced and decomposed on the anode, the electrolyte solution deteriorates when the charge-discharge cycle is repeated, and a decrease in capacity or an increase in internal resistance due to a decomposition product occurs. In order to solve the above problems, JP-A-2005-101003 discloses a technique that adds vinylene carbonate to the electrolyte solution. According to the technique disclosed in JP-A-2005-101003, decomposition of the carboxylic ester is suppressed by a protective film formed on the anode, and a deterioration in the electrolyte solution due to the charge-discharge cycle can be reduced.

JP-A-2004-6240 discloses that a high-voltage lithium-ion capacitor having a high energy density can be produced by utilizing a lithium salt (e.g., lithium tetracyanoborate (LiB(CN)₄)) having a wide potential window as the solute of the electrolyte solution.

### SUMMARY OF THE INVENTION

### Technical Problem

However, the composition of the electrolyte solution has not been known that makes it possible to produce a lithium-ion capacitor that utilizes a lithium salt (e.g., lithium tetracyanoborate (LiB(CN)₄)) having a wide potential window as the solute of the electrolyte solution, and rarely shows a deterioration in charge-discharge characteristics.

Several aspects of the invention may solve the above problems, and may provide a high-voltage lithium-ion capacitor having a high energy density for which a deterioration due to the charge-discharge cycle can be reduced.

### Solution to Problem

The invention was conceived in order to solve at least some of the above problems, and may be implemented as the following aspects or application examples.

### Application Example 1

According to one aspect of the invention, a lithium-ion capacitor includes a non-aqueous electrolyte solution that includes (A) a compound represented by a general formula (1), (B) a cyclic carbonate ester that includes at least one carbon-carbon unsaturated bond, and (C) a carboxylic ester, the non-aqueous electrolyte solution having a ratio (M_{B}/M_{C}) of 0.001 to 0.5, the ratio (M_{B}/M_{C}) being a ratio of a content (M_{B}) (mmol/g) of the cyclic carbonate ester (B) to a content (M_{C}) (mmol/g) of the carboxylic ester (C),

Z⁺.[X(CN)ₘ(Y)ₙ]⁻ (1)

wherein X is at least one element selected from boron, aluminum, silicon, phosphorus, and arsenic, Y is a halogen, Z is lithium or magnesium, m is an integer from 3 to 6, and n is an integer from 0 to 5, provided that m+n≧3.

### Application Example 2

In the lithium-ion capacitor according to Application Example 1, the compound (A) may be at least one compound selected from LiB(CN)₄ and LiP(CN)₆.

### Application Example 3

In the lithium-ion capacitor according to Application Example 1 or 2, the cyclic carbonate ester (B) may be a compound represented by a general formula (2),

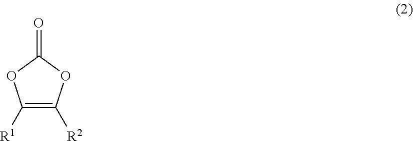

wherein R¹ and R² are independently a hydrogen atom, a halogen atom, an alkyl group having 1 to 6 carbon atoms, an alkenyl group having 1 to 6 carbon atoms, or a phenyl group.

### Application Example 4

In the lithium-ion capacitor according to Application Example 1 or 2, the cyclic carbonate ester (B) may be at least one compound selected from vinylene carbonate, vinyl ethylene carbonate, divinyl ethylene carbonate, and fluorovinylene carbonate.

### Application Example 5

In the lithium-ion capacitor according to any one of Application Examples 1 to 4, the carboxylic ester (C) may be a compound represented by a general formula (3),

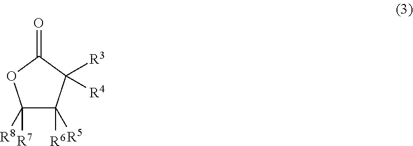

wherein R³ to R⁸ are independently a hydrogen atom, a halogen atom, an alkyl group having 1 to 6 carbon atoms, or an acetyl group.

### Application Example 6

In the lithium-ion capacitor according to any one of Application Examples 1 to 4, the carboxylic ester (C) may be at least one compound selected from gamma-butyrolactone and derivatives thereof

### Advantageous Effects of the Invention

According to the aspect of the invention, it is possible to provide a high-voltage lithium-ion capacitor having a high energy density for which a deterioration due to the charge-discharge cycle can be reduced. In particular, it is possible to provide a lithium-ion capacitor which utilizes a lithium salt (e.g., lithium tetracyanoborate (LiB(CN)₄)) having a wide potential window as the solute of the electrolyte solution, and for which a deterioration in charge-discharge characteristics can be effectively reduced.

### DESCRIPTION OF EMBODIMENTS

Exemplary embodiments of the invention are described in detail below.

### 1. Lithium-Ion Capacitor

A lithium-ion capacitor according to one embodiment of the invention includes a non-aqueous electrolyte solution that includes (A) a compound represented by the following general formula (1) (hereinafter may be referred to as “component (A)”), (B) a cyclic carbonate ester that includes at least one carbon-carbon unsaturated bond (hereinafter may be referred to as “component (B)”), and (C) a carboxylic ester (hereinafter may be referred to as “component (C)”), the non-aqueous electrolyte solution having a ratio (M_{B}/M_{C}) of 0.001 to 0.5, the ratio (M_{B}/M_{C}) being the ratio of the content (M_{B}) (mmol/g) of the component (B) to the content (M_{C}) (mmol/g) of the component (C).

Z⁺.[X(CN)ₘ(Y)ₙ]⁻ (1)

wherein X is at least one element selected from boron, aluminum, silicon, phosphorus, and arsenic, Y is a halogen, Z is lithium or magnesium, m is an integer from 3 to 6, and n is an integer from 0 to 5, provided that m+n≧3.

The components of the non-aqueous electrolyte solution included in the lithium-ion capacitor according to one embodiment of the invention are described in detail below.

### 1.1. Non-Aqueous Electrolyte Solution

### 1.1.1. Component (A)

The non-aqueous electrolyte solution included in the lithium-ion capacitor according to one embodiment of the invention includes the compound represented by the general formula (1) as the component (A). The component (A) is a solute that can provide the non-aqueous electrolyte solution with electrical conductivity. The Gaussian 03 calculation results show that the component (A) exhibits high oxidation resistance as compared with F₆P⁻, F₄B⁻, and the like that are added to a normal non-aqueous electrolyte solution, and it is considered that the component (A) is not easily decomposed even at an oxidation potential of +10 V. Therefore, it is conjectured that the potential window of the non-aqueous electrolyte solution can be extended by adding the component (A). It is expected that the operating voltage of the lithium-ion capacitor can be increased, and a high energy density can be achieved by applying such a non-aqueous electrolyte solution to the lithium-ion capacitor. Moreover, since the component (A) has a thermal decomposition start temperature of 400° C. or more, it is possible to provide a safe non-aqueous electrolyte solution for which a deterioration is suppressed.

X in the general formula (1) is at least one element selected from boron, aluminum, silicon, phosphorus, and arsenic. An element necessary for the lithium-ion capacitor may be appropriately selected as X. Y in the general formula (1) is a halogen. It is preferable that the component (A) be a compound that does not include Y (i.e., n=0) (i.e., exhibits excellent oxidation-reduction resistance) from the viewpoint of further improving the charge-discharge characteristics of the lithium-ion capacitor. Z in the general formula (1) is lithium or magnesium. An element necessary for the lithium-ion capacitor may be appropriately selected as Z.

LiSi(CN)₃, LiB(CN)₄, LiAl(CN)₄, LiP(CN)₆, LiAs(CN)₆, and combinations thereof with another alkali/alkaline-earth metal (salt of another alkali/alkaline-earth metal) are preferable as the component (A), for example. It is preferable that the component (A) be at least one compound selected from LiB(CN)₄ and LiP(CN)₆ (more preferably LiB(CN)₄) due to excellent solubility in the non-aqueous solvent. The compounds represented by the general formula (1) may be used either alone or in combination.

The content of the component (A) in the non-aqueous electrolyte solution is appropriately set depending on the application of the non-aqueous electrolyte solution and the like. For example, the content of the component (A) in the non-aqueous electrolyte solution is preferably 1.0×10⁻¹ to 2.0×10⁰ mmol/g, and more preferably 3.0×10⁻¹ to 1.0×10⁰ mmol/g, based on the total mass of the non-aqueous electrolyte solution. When the content of the component (A) is within the above range, the component (A) can be dissolved in the non-aqueous solvent, and high ion conductivity is achieved due to a sufficiently high ion concentration in the non-aqueous electrolyte solution.

The component (A) may be produced by an arbitrary method. For example, stable and high-purity [B(CN)₄]⁻ can be produced by reacting a cyanogen compound that includes a specific metal (i.e., one metal selected from Zn, Ga, Pd, Sn, Hg, Rh, Cu, and Pb) with a boron compound as starting materials (see JP-A-2010-13433). Since [B(CN)₄]⁻ that is produced by the above production method has a low impurity (e.g., water) content as compared with a salt that includes (PF₆)⁻, (BF₄)—, or the like as the anion, a deterioration in the electrode does not occur during the charge-discharge cycle.

### 1.1.2. Component (B)

The non-aqueous electrolyte solution included in the lithium-ion capacitor according to one embodiment of the invention includes the cyclic carbonate ester that includes at least one carbon-carbon unsaturated bond as the component (B). The component (B) can form a protective film on the anode, and suppress decomposition of the carboxylic ester (C) on the anode.

The component (B) is preferably a compound represented by the following general formula (2).

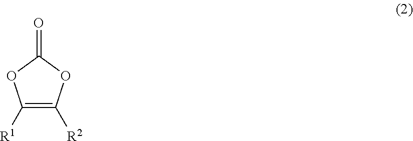

wherein R¹ and R² are independently a hydrogen atom, a halogen atom, an alkyl group having 1 to 6 carbon atoms, an alkenyl group having 1 to 6 carbon atoms, or a phenyl group.

Specific examples of the component (B) include vinylene carbonate (VC), 3-methyl vinylene carbonate, 3,4-dimethyl vinylene carbonate, 3-ethyl vinylene carbonate, 3,4-diethyl vinylene carbonate, 3-propyl vinylene carbonate, 3,4-dipropyl vinylene carbonate, 3-phenyl vinylene carbonate, 3,4-diphenyl vinylene carbonate, vinyl ethylene carbonate (VEC), divinyl ethylene carbonate (DVEC), fluorovinylene carbonate, and the like. These compounds may be used either alone or in combination. Note that some of the hydrogen atoms of these compounds may be substituted with a fluorine atom. In particular, when at least one compound selected from vinylene carbonate, vinyl ethylene carbonate, and divinyl ethylene carbonate is used as the component (B), the component (B) efficiently forms a protective film on the anode, and exhibits an improved effect of suppressing hydrolysis of the carboxylic ester (C).

The content of the component (B) in the non-aqueous electrolyte solution is appropriately set depending on the application of the non-aqueous electrolyte solution and the like. For example, the content of the component (B) in the non-aqueous electrolyte solution is preferably 1.0×10⁻² to 4.0×10⁰ mmol/g, and more preferably 1.0×10⁻¹ to 2.0×10⁰ mmol/g, based on the total mass of the non-aqueous electrolyte solution. When the content of the component (B) is within the above range, the component (B) forms a moderate protective film on the anode without forming an excessive protective film. Moreover, an increase in internal resistance due to a decomposition product is suppressed as a result of suppressing decomposition of the carboxylic ester (C). These advantages make it possible to implement a lithium-ion capacitor that exhibits excellent charge-discharge characteristics. Note that the component (B) functions as a poor solvent for the component (A) in the non-aqueous electrolyte solution. However, the component (A) can be sufficiently dissolved when the content of the component (B) is within the above range. Therefore, when the content of the component (B) is within the above range, it is possible to produce a stable non-aqueous electrolyte solution in which the component (A) does not precipitate over a wide temperature range.

### 1.1.3. Component (C)

The non-aqueous electrolyte solution included in the lithium-ion capacitor according to one embodiment of the invention includes the carboxylic ester as the component (C). The component (C) is preferably a carboxylic ester that has a cyclic ether structure, and more preferably a compound represented by the following general formula (3).

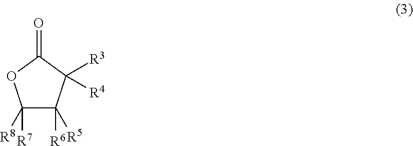

wherein R³ to R⁸ are independently a hydrogen atom, a halogen atom, an alkyl group having 1 to 6 carbon atoms, or an acetyl group.

Specific examples of the component (C) include propylene carbonate (PC), ethylene carbonate (EC), butylene carbonate (BC), gamma-butyrolactone (GBL), gamma-valerolactone (GVL), alpha-acetyl-gamma-butyrolactone, alpha-methyl-gamma-butyrolactone, beta-methyl-gamma-butyrolactone, alpha-angelicalactone, alpha-methylene-gamma-butyrolactone, gamma-hexanolactone, gamma-nonalactone, gamma-octanolactone, gamma-methyl-gamma-decanolactone, derivatives thereof, and the like. These compounds may be used either alone or in combination. Note that some of the hydrogen atoms of these compounds may be substituted with a fluorine atom.

It is preferable to use at least one compound selected from gamma-butyrolactone and derivatives thereof as the component (C) since the component (A) can be dissolved at a high concentration.

The content of the component (C) in the non-aqueous electrolyte solution is appropriately set depending on the application of the non-aqueous electrolyte solution and the like. For example, the content of the component (C) in the non-aqueous electrolyte solution is preferably 1 to 20 mmol/g, and more preferably 5 to 15 mmol/g, based on the total mass of the non-aqueous electrolyte solution. When the content of the component (C) is within the above range, the component (A) can be dissolved at a high concentration.

### 1.1.4. Additive

The non-aqueous electrolyte solution included in the lithium-ion capacitor according to one embodiment of the invention may further include (D) a chain-like carbonate ester. The viscosity of the non-aqueous solvent can be reduced by adding the chain-like carbonate ester (D), so that the charge-discharge characteristics of the lithium-ion capacitor at a low temperature can be further improved. Examples of the chain-like carbonate ester (D) include dimethyl carbonate (DMC), ethyl methyl carbonate (EMC), diethyl carbonate (DEC), and the like. These compounds may be used either alone or in combination. The content of the chain-like carbonate ester (D) in the non-aqueous electrolyte solution is preferably 50 vol % or less, more preferably 0.1 to 30 vol %, and particularly preferably 0.1 to 20 vol %.

The non-aqueous electrolyte solution included in the lithium-ion capacitor according to one embodiment of the invention may optionally further include an organic solvent, an ionic liquid, a polymer electrolyte, an inorganic solid electrolyte, and the like that may be added to a non-aqueous electrolyte solution for a lithium-ion capacitor.

### 1.1.5. Relationship Between Content of Component (B) and Content of Component (C)

The non-aqueous electrolyte solution included in the lithium-ion capacitor according to one embodiment of the invention is characterized in that the ratio (M_{B}/M_{C}) of the content (M_{B}) (mmol/g) of the component (B) to the content (M_{C}) (mmol/g) of the component (C) is 0.001 to 0.5. The ratio (M_{B}/M_{C}) is preferably 0.005 to 0.35, and more preferably 0.02 to 0.1. When the ratio (M_{B}/M_{C}) is within the above range, the component (B) forms a moderate protective film on the anode without forming an excessive protective film. Moreover, an increase in internal resistance due to a decomposition product is suppressed as a result of suppressing decomposition of the carboxylic ester (C). These advantages make it possible to implement a lithium-ion capacitor that exhibits excellent charge-discharge characteristics.

If the ratio (M_{B}/M_{C}) is less than the above range, the component (B) may not form a sufficient protective film on the anode, and decomposition of the component (C) may not be suppressed. As a result, an increase in internal resistance due to a decomposition product may occur when the charge-discharge cycle is repeated. These drawbacks may make it impossible to implement a lithium-ion capacitor that exhibits excellent charge-discharge characteristics.

If the ratio (M_{B}/M_{C}) exceeds the above range, the solubility of the component (A) in the non-aqueous electrolyte solution may significantly decrease, and sufficient ion conductivity may not be obtained. If the ratio (M_{B}/M_{C}) exceeds the above range, the component (B) may form an excessive protective film on the anode at a high temperature. The excessive protective film may hinder smooth insertion/extraction of lithium ions into/from the anode, and the charge-discharge characteristics of the lithium-ion capacitor may significantly deteriorate.

### 1.2. Cathode and Anode

A cathode and an anode that are normally used for a lithium-ion capacitor may be used as the cathode and the anode included in the lithium-ion capacitor that utilizes the non-aqueous electrolyte solution. The cathode active material and the anode active material described below may be used for the lithium-ion capacitor according to one embodiment of the invention, for example.

Examples of the cathode active material include activated carbon, a polyacene-based organic semiconductor (PAS) having a polyacene-based skeleton (structure) that is obtained by subjecting an aromatic fused polymer to a heat treatment and has a hydrogen/carbon atomic ratio of 0.05 to 0.50, and the like. Among these, activated carbon is particularly preferable.

A material that can be undoped or doped with lithium metal or lithium may be used as the anode active material. Examples of the material that can be undoped or doped with lithium include carbon materials such as pyrolytic carbon, coke (e.g., pitch coke, needle coke, and petroleum coke), graphite, glassy carbon, an organic polymer compound calcined product (i.e., a product obtained by calcining and carbonizing a phenol resin, a furan resin, or the like at an appropriate temperature), carbon fibers, and activated carbon, polymers such as polyacetylene, polypyrrole, and polyacene, and lithium-containing transition metal oxides or sulfides such as Li_{4/3}Ti_{5/3}O₄ and TiS₂. Among these, the carbon materials are preferable, and graphite is particularly preferable.

The cathode active material is mixed with a binder and a conductive agent to prepare a paste, and the paste is applied to a collector made of an aluminum foil to obtain an electrode plate, for example. The anode active material is mixed with a binder and a conductive agent to prepare a paste, and the paste is applied to a collector made of a copper foil to obtain an electrode plate, for example. A known binder and a known conductive agent may be used as the binder and the conductive agent.

### 1.3. Separator

The lithium-ion capacitor according to one embodiment of the invention includes a separator that is positioned between the cathode and the anode. The separator prevents a short circuit due to contact between the cathode and the anode, and retains the non-aqueous electrolyte solution to provide ion conductivity. A separator that is normally used for a lithium-ion capacitor may be used as the separator. It is preferable that the separator be a microporous membrane. Examples of a material for forming the separator include polyolefins (e.g., polyethylene and polypropylene) and cellulose paper.

### 1.4. Usage

The lithium-ion capacitor according to one embodiment of the invention may be a cylindrical lithium-ion capacitor, a laminate-type lithium-ion capacitor, or the like. The shape of the cathode, the anode, and the separator (optional) may be appropriately changed corresponding to the shape of the lithium-ion capacitor.

### 2. Examples

The invention is further described below by way of examples. Note that the invention is not limited to the following examples.

### 2.1. Preparation and Evaluation of Non-Aqueous Electrolyte Solution

### 2.1.1. Preparation of Non-Aqueous Electrolyte Solution

In a glovebox in which the atmosphere had been replaced with Ar so that the dew point was −80° C. or less, 8.0 g (6.6×10⁻² mol) of lithium tetracyanoborate (“IX-1-NE-203” manufactured by Nippon Shokubai Co., Ltd.) (component (A)), 5.0 g (5.8×10⁻² mol) of vinylene carbonate (“LBG-84922” manufactured by Kishida Chemical Co., Ltd.) (component (B)), and 87 g (1.0 mol) of gamma-butyrolactone (“LBG-11785” manufactured by Kishida Chemical Co., Ltd.) (component (C)) were mixed to prepare a non-aqueous electrolyte solution used for the lithium-ion capacitor of Example 1.

Non-aqueous electrolyte solutions used for the lithium-ion capacitors of Examples 2 to 4 and Comparative Examples 1 to 11 were prepared in the same manner as the non-aqueous electrolyte solution used for the lithium-ion capacitor of Example 1, except that the amounts and the types of the component (A), the component (B), the component (C), and the optional component were changed as shown in Table 1.

The meaning of each abbreviation in Table 1 is shown below.

LiTCB: lithium tetracyanoborate (“IX-1-NE-203” manufactured by Nippon Shokubai Co., Ltd.)
LiPF₆: lithium hexafluorophosphate (“LBG-45864” manufactured by Kishida Chemical Co., Ltd.)
VC: vinylene carbonate (“LBG-84922” manufactured by Kishida Chemical Co., Ltd.)
GBL: gamma-butyrolactone (“LBG-11785” manufactured by Kishida Chemical Co., Ltd.)
EC: ethylene carbonate (“LBG-29015” manufactured by Kishida Chemical Co., Ltd.)
EMC: ethyl methyl carbonate (“LBG-31385” manufactured by Kishida Chemical Co., Ltd.)
DEC: diethyl carbonate (“LBG-23605” manufactured by Kishida Chemical Co., Ltd.)
PC: propylene carbonate (“LBG-64950” manufactured by Kishida Chemical Co., Ltd.)

### 2.1.2. Evaluation of Solubility of Non-Aqueous Electrolyte Solution

In a glovebox in which the atmosphere had been replaced with Ar so that the dew point was −80° C. or less, 10 ml of the non-aqueous electrolyte solution prepared as described above (see “2.1.1. Preparation of non-aqueous electrolyte solution”) was put in a 20 ml vial container. After sealing the vial container, the non-aqueous electrolyte solution was allowed to stand at room temperature for 16 hours, and the external appearance of the non-aqueous electrolyte solution was evaluated with the naked eye. The evaluation criteria are shown below. The evaluation results are shown in Table 1.

Acceptable: The non-aqueous electrolyte solution was transparent.
Fair: The non-aqueous electrolyte solution was cloudy, but no precipitate was observed.
Unacceptable: The non-aqueous electrolyte solution was cloudy, and a precipitate was observed.

When the non-aqueous electrolyte solution was transparent, it was determined that the solute was sufficiently dissolved, and the non-aqueous electrolyte solution can be advantageously used as an electrolyte solution. When the non-aqueous electrolyte solution was cloudy, but no precipitate was observed, it was determined that the non-aqueous electrolyte solution can be used as an electrolyte solution although the non-aqueous electrolyte solution is close to a saturated state. When a precipitate was observed, it was determined that the composition of the non-aqueous electrolyte solution was non-uniform, and the non-aqueous electrolyte solution cannot be applied to a lithium-ion capacitor.

### 2.2. Production of Lithium-Ion Capacitor Cell

### 2.2.1. Production of Anode

A twin-screw planetary mixer (“TK HIVIS MIX 2P-03” manufactured by PRIMIX Corporation) was charged with 1.5 parts by mass (based on solid content) of a thickener (“CMC1120” manufactured by Daicel Corporation), 100 parts by mass (based on solid content) of graphite (anode active material), and 68 parts by mass of water. The mixture was stirred at 60 rpm for 1 hour. After the addition of 1 part by mass (based on solid content) of an electrochemical device electrode binder (“TRD2001” manufactured by JSR Corporation), the mixture was stirred for 1 hour to obtain a paste. After the addition of water to the paste so that the solid content was 50%, the mixture was stirred at 200 rpm for 2 minutes, stirred at 1800 rpm for 5 minutes, and stirred at 1800 rpm for 1.5 minutes under vacuum using a stirrer/deaerator (“THINKY Mixer (Awatori Rentarou)” manufactured by THINKY Corporation) to prepare an electrochemical device electrode slurry. The electrochemical device electrode slurry was uniformly applied to the surface of a collector made of a copper foil using a doctor blade method so that the thickness after drying was 80 micrometers. The electrochemical device electrode slurry was then dried at 120° C. for 20 minutes to obtain an anode for a lithium-ion capacitor.

### 2.2.2. Production of Cathode

A twin-screw planetary mixer (“TK HIVIS MIX 2P-03” manufactured by PRIMIX Corporation) was charged with 6.0 parts by mass (based on solid content) of an electrochemical device electrode binder (“TRD201A” manufactured by JSR Corporation), 3.5 parts by mass (based on solid content) of a thickener (“CMC1120” manufactured by Daicel Corporation), 7.0 parts by mass of a conductive aid (“HS-100” manufactured by Denki Kagaku Kogyo Kabushiki Kaisha), and 84 parts by mass (based on solid content) of a cathode active material (“MSP-20S” manufactured by Kansai Coke and Chemicals Co., Ltd.). The mixture was stirred at 60 rpm for 2 hours to prepare a paste. After the addition of water to the paste so that the solid content was 65%, the mixture was stirred at 200 rpm for 2 minutes, stirred at 1800 rpm for 5 minutes, and stirred at 1800 rpm for 1.5 minutes under vacuum using a stirrer/deaerator (“THINKY Mixer (Awatori Rentarou)” manufactured by THINKY Corporation) to prepare an electrochemical device electrode slurry. The electrochemical device electrode slurry was uniformly applied to the surface of a collector made of an aluminum foil using a doctor blade method so that the thickness after drying was 80 micrometers. The electrochemical device electrode slurry was then dried at 120° C. for 20 minutes to obtain a cathode for a lithium-ion capacitor.

### 2.2.3. Assembly of Anode-Lithium Half-Cell

In a glovebox in which the atmosphere was replaced with Ar so that the dew point was −80° C., an anode (diameter: 15.95 mm) obtained by cutting the anode produced as described above (see “2.2.1. Production of anode”) was placed on a two-electrode coin cell (“HS Flat Cell” manufactured by Hohsen Corp.). A separator (“Celgard #2400” manufactured by Celgard, LLC.) (diameter: 24 mm) obtained by cutting a polypropylene porous membrane was placed on the anode, and 500 microliters of the electrolyte solution prepared as described above (see “2.1.1. Preparation of non-aqueous electrolyte solution”) was injected into the two-electrode coin cell while avoiding entrance of air. A Li metal foil that was cut to a diameter of 16.16 mm was placed on the separator to seal the cell. A half-cell including an anode and an Li electrode was thus obtained.

2.2.4. Pre-Doping of Anode with Li Ions

The half-cell produced as described above (see “2.2.3. Assembly of anode-lithium half-cell”) was connected to a charge-discharge measurement system (“HJ1001SM8A” manufactured by Hokuto Denko Corporation, cell: room temperature), and charged at a constant current (0.3 mA) for 8 hours to pre-dope the anode with Li ions.

### 2.2.5. Assembly of Lithium-Ion Capacitor Cell

In a glovebox in which the atmosphere had been replaced with Ar so that the dew point was −80° C. or less, the Li metal foil was removed from the half-cell produced as described above (see “2.2.4. Pre-doping of anode with Li ions”), and the cathode produced as described above (see “2.2.2. Production of cathode”) was placed in place of the Li metal foil to seal the cell. A lithium-ion capacitor cell was thus produced.

### 2.3. Evaluation of Charge-Discharge Characteristics

### 2.3.1. Evaluation of Discharge Capacity and Coulombic Efficiency (Basic Charge-Discharge Characteristics)

The lithium-ion capacitor cell produced as described above (see “2.2. Production of lithium-ion capacitor cell”) was connected to the charge-discharge measurement system, and the discharge capacity and the coulombic efficiency were evaluated.

The lithium-ion capacitor cell was charged at a constant current (0.3 mA), and determined to be fully charged (cut-off) when the voltage reached 4.2 V. The lithium-ion capacitor cell was then discharged at a constant current (0.3 mA), and determined to be fully discharged (cut-off) when the voltage reached 3.2 V.

The coulombic efficiency (%) (indicated by the ratio of the discharge capacity to the charge capacity) was calculated from the charge capacity and the discharge capacity measured as described above. Table 1 shows the discharge capacity and the coulombic efficiency (at 0.3 mA) of the lithium-ion capacitors of Examples 1 to 4 and Comparative Examples 1 to 11.

When the discharge capacity at 0.3 mA was 6.5 mAh/g or more, it was determined that the capacity was sufficient.

When the coulombic efficiency at 0.3 mA was 88% or more, it was determined that a protective film was efficiently formed on the surface of the anode during initial charge/discharge, and the energy loss due to the irreversible reaction was small. When the coulombic efficiency at 0.3 mA was less than 88%, it was determined that a protective film was not efficiently formed on the surface of the anode, and the energy loss due to the irreversible reaction was large.

### 2.3.2. Evaluation of DC Internal Resistance (DC-IR)

The lithium-ion capacitor cell subjected to the evaluation of the discharge capacity and the coulombic efficiency (see “2.3.1. Evaluation of discharge capacity and coulombic efficiency (basic charge-discharge characteristics)” was charged up to 4.2 V at a constant current (0.6 mA). The lithium-ion capacitor cell was then charged at a constant current (0.6 mA) for 10 seconds to determine a change in voltage, allowed to stand for 1 minute, and discharged at a constant current (1.2 mA) for 10 seconds to determine a change in voltage. The voltage when charging and discharging the lithium-ion capacitor cell was determined in the same manner as described above while changing the current value from 0.6 mA to 1.2 mA, 1.8 mA, 3.0 mA, and 5.0 mA.

A graph was drawn by plotting the current value (A) (horizontal axis) and the voltage (V) (vertical axis), and the slope of a straight line that connects the plotted points was calculated. The slope was evaluated as the DC internal resistance (DC-IR) during charge and discharge. Table 1 shows the DC internal resistance (DC-IR) of the lithium-ion capacitors of Examples 1 to 4 and Comparative Examples 1 to 11 during charge and discharge.

When the DC internal resistance (DC-IR) during charge and discharge was 5.5 ohms or less, it was determined that the resistance due to a protective film formed on the surface of the anode was low.

### 2.3.3. Evaluation of Cycle Characteristics

The lithium-ion capacitor cell subjected to the evaluation of the DC internal resistance (DC-IR) (see “2.3.2. Evaluation of DC internal resistance (DC-1R)” was charged at a constant current (0.3 mA), and determined to be fully charged (cut-off) when the voltage reached 4.2 V. The lithium-ion capacitor cell was then discharged at a constant current (0.3 mA), and determined to be fully discharged (cut-off) when the voltage reached 3.2 V, and the discharge capacity in the first cycle was calculated. The charge-discharge operation was repeated 10 times, and the discharge capacity in the tenth cycle was calculated.

A value obtained by dividing the discharge capacity in the tenth cycle by the discharge capacity in the first cycle was taken as a 10-cycle discharge capacity retention ratio (%). Table 1 shows the 10-cycle discharge capacity retention ratio of the lithium-ion capacitors of Examples 1 to 4 and Comparative Examples 1 to 11.

When the 10-cycle discharge capacity retention ratio was 50% or more, it was determined that a stable protective film formed on the surface of the anode suppressed the irreversible reaction during the charge-discharge cycle.

TABLE 1

| | | | | | | | Com- | Com- | Com- | Com- | Com- | Com- | Com- | Com- | Com- | Com- | Com- |
|---|---|---|---|---|---|---|---|---|---|---|---|---|---|---|---|---|---|
| | | | | | | | parative | parative | parative | parative | parative | parative | parative | parative | parative | parative | parative |
| | | | Ex- | Ex- | Ex- | Ex- | Ex- | Ex- | Ex- | Ex- | Ex- | Ex- | Ex- | Ex- | Ex- | Ex- | Ex- |
| | | | ample 1 | ample 2 | ample 3 | ample 4 | ample 1 | ample 2 | ample 3 | ample 4 | ample 5 | ample 6 | ample 7 | ample 8 | ample 9 | ample 10 | ample 11 |
| Compo- | Component | Type | LiTCB | LiTCB | LiTCB | LiTCB | — | — | LiTCB | LiTCB | LiTCB | LiTCB | LiTCB | LiTCB | LiTCB | LiTCB | LiTCB |
| sition of | (A) | Amount | 0.66 | 0.66 | 0.66 | 0.66 | | | 0.66 | 0.66 | 0.66 | 0.66 | 0.66 | 0.66 | 0.66 | 0.66 | 0.66 |
| electrolyte | | (mmol/g) | | | | | | | | | | | | | | | |
| solution | Component | Type | VC | VC | VC | VC | VC | — | — | VC | VC | VC | — | — | — | VC | VC |
| | (B) | Amount | 0.58 | 0.23 | 0.06 | 2.91 | 0.58 | | | 0.00 | 0.01 | 0.58 | | | | 4.07 | 5.81 |
| | | (mmol/g) | | | | | | | | | | | | | | | |
| | Component | Type | GBL | GBL | GBL | GBL | GBL | GBL | GBL | GBL | GBL | — | — | — | — | GBL | GBL |
| | (C) | Amount | 10.12 | 10.47 | 10.64 | 7.79 | 10.12 | 10.70 | 8.37 | 10.70 | 10.70 | | | | | 6.63 | 4.88 |
| | | (mmol/g) | | | | | | | | | | | | | | | |
| | Additional | Type | — | — | — | — | LiPF6 | LiPF6 | — | — | — | — | — | — | — | — | — |
| | Component | Amount | | | | | 0.66 | 0.66 | | | | | | | | | |
| | | (mmol/g) | | | | | | | | | | | | | | | |
| | | Type | — | — | — | — | — | — | — | — | — | EC | EC | EC | PC | — | — |
| | | Amount | | | | | | | | | | 26.10 | 26.00 | 26.00 | 92.00 | | |
| | | (mmol/g) | | | | | | | | | | | | | | | |
| | | Type | — | — | — | — | — | — | — | — | — | EMC | EMC | DEC | — | — | — |
| | | Amount | | | | | | | | | | 60.90 | 61.00 | 61.00 | | | |
| | | (mmol/g) | | | | | | | | | | | | | | | |
| | M_{B}/M_{C} | | 0.0575 | 0.0222 | 0.0055 | 0.3731 | 0.0575 | 0.0000 | 0.0000 | 0.0001 | 0.0005 | — | — | — | — | 0.6140 | 1.1905 |
| | Electrolyte solubility | | Accept- | Accept- | Accept- | Fair | Accept- | Accept- | Accept- | Accept- | Accept- | Unaccept- | Unaccept- | Unaccept- | Unaccept- | Unaccept- | Unaccept- |
| | | | able | able | able | | able | able | able | able | able | able | able | able | able | able | able |
| Character- | Discharge capacity | | 6.7 | 6.9 | 7.0 | 6.6 | 6.4 | 6.6 | 6.3 | 6.2 | 6.3 | Could | Could | Could | Could | Could | Could |
| istics of | (mAh/g) | | | | | | | | | | | not be | not be | not be | not be | not be | not be |
| lithium- | Coulombic | | 88 | 88 | 88 | 89 | 86 | 81 | 79 | 81 | 85 | evaluated | evaluated | evaluated | evaluated | evaluated | evaluated |
| ion | efficiency(%) | | | | | | | | | | | | | | | | |
| capacitor | DC-1R | Charge | 4.0 | 4.3 | 4.5 | 4.6 | 5.4 | 7.1 | 6.1 | 5.0 | 5.0 | | | | | | |
| | | (ohms) | | | | | | | | | | | | | | | |
| | | Dis- | 4.2 | 5.1 | 5.2 | 5.2 | 6.1 | 8.5 | 7.9 | 7.5 | 6.0 | | | | | | |
| | | charge | | | | | | | | | | | | | | | |
| | | (ohms) | | | | | | | | | | | | | | | |

| | | | | | | | | | |
|---|---|---|---|---|---|---|---|---|---|
| 10-cycle discharge | 78% | 63% | 50% | 59% | 34% | 9% | 18% | 21% | 29% |
| capacity retention | | | | | | | | | |
| ratio | | | | | | | | | |

### 2.4. Evaluation Results

Since the lithium-ion capacitors of Examples 1 to 4 had a large a discharge capacity as a result of using the electrolyte solution having a wide potential window, and could be charged and discharged without showing a deterioration in the electrolyte solution, the lithium-ion capacitors of Examples 1 to 4 showed excellent results for the discharge capacity, the coulombic efficiency, the DC internal resistance (DC-IR), and the cycle characteristics.

In contrast, since the high-potential-side potential window of the lithium-ion capacitors of Comparative Examples 1 and 2 in which lithium hexafluorophosphate (LiPF₆) (common electrolyte) was used instead of the component (A), was less than 10 V, the non-aqueous electrolyte solution underwent an electrolytic reaction in a high-potential region. As a result, the lithium-ion capacitors of Comparative Examples 1 and 2 showed poor results for the discharge capacity, the coulombic efficiency, the DC internal resistance (DC-IR), and the cycle characteristics (i.e., exhibited poor charge-discharge characteristics).

The lithium-ion capacitor of Comparative Example 3 in which the component (B) was not used, showed poor results for the discharge capacity, the coulombic efficiency, the DC internal resistance (DC-IR), and the cycle characteristics (i.e., exhibited poor charge-discharge characteristics).

The lithium-ion capacitors of Comparative Examples 4 and 5 were produced using the non-aqueous electrolyte solution having a ratio (M_{B}/M_{C}) of less than 0.001. As a result, the lithium-ion capacitors of Comparative Examples 4 and 5 showed poor results for the discharge capacity, the coulombic efficiency, the DC internal resistance (DC-IR), and the cycle characteristics (i.e., exhibited poor charge-discharge characteristics).

The lithium-ion capacitors of Comparative Examples 6 to 9 were produced using a component (vinylene carbonate, ethylene carbonate, ethyl methyl carbonate, diethyl carbonate, propylene carbonate) that is used for a normal non-aqueous electrolyte solution. However, since the component (A) was not completely dissolved, the lithium-ion capacitors could not be evaluated.

The lithium-ion capacitors of Comparative Examples 10 and 11 were produced using the non-aqueous electrolyte solution having a ratio (M_{B}/M_{C}) of more than 0.5. However, since the component (A) was not completely dissolved, the lithium-ion capacitors could not be evaluated.

The invention is not limited to the above embodiments. Various modifications and variations may be made of the above embodiments. For example, the invention includes various other configurations substantially the same as the configurations described in connection with the above embodiments (e.g., a configuration having the same function, method, and results, or a configuration having the same objective and results). The invention also includes a configuration in which an unsubstantial part (element) described in connection with the above embodiments is replaced with another part (element). The invention also includes a configuration having the same effects as those of the configurations described in connection with the above embodiments, or a configuration capable of achieving the same objective as that of the configurations described in connection with the above embodiments. The invention further includes a configuration in which a known technique is added to the configurations described in connection with the above embodiments.

1: A lithium-ion capacitor comprising a non-aqueous electrolyte solution that comprises (A) a compound represented by a general formula (1), (B) a cyclic carbonate ester that includes at least one carbon-carbon unsaturated bond, and (C) a carboxylic ester, the non-aqueous electrolyte solution having a ratio (M_{B}/M_{C}) of 0.001 to 0.5, the ratio (M_{B}/M_{C}) being a ratio of a content (M_{B}) (mmol/g) of the cyclic carbonate ester (B) to a content (M_{C}) (mmol/g) of the carboxylic ester (C),
Z⁺.[X(CN)ₘ(Y)ₙ]⁻ (1)
wherein X is at least one element selected from the group consisting of boron, aluminum, silicon, phosphorus, and arsenic, Y is a halogen, Z is lithium or magnesium, m is an integer from 3 to 6, and n is an integer from 0 to 5, provided that m+n≧3.

2: The lithium-ion capacitor according to claim 1, wherein the compound (A) is at least one compound selected from the group consisting of LiB(CN)₄ and LiP(CN)₆.

3: The lithium-ion capacitor according to claim 1, wherein the cyclic carbonate ester (B) is a compound represented by a general formula (2), 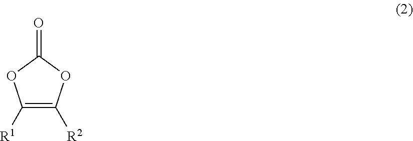
wherein R¹ and R² are independently a hydrogen atom, a halogen atom, an alkyl group having 1 to 6 carbon atoms, an alkenyl group having 1 to 6 carbon atoms, or a phenyl group.

4: The lithium-ion capacitor according to claim 1, wherein the cyclic carbonate ester (B) is at least one compound selected from the group consisting of vinylene carbonate, vinyl ethylene carbonate, divinyl ethylene carbonate, and fluorovinylene carbonate.

5: The lithium-ion capacitor according to claim 1, wherein the carboxylic ester (C) is a compound represented by a general formula (3), 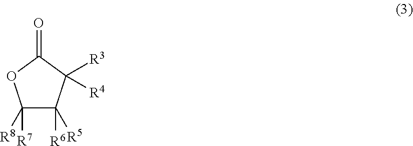
wherein R³ to R⁸ are independently a hydrogen atom, a halogen atom, an alkyl group having 1 to 6 carbon atoms, or an acetyl group.

6: The lithium-ion capacitor according to claim 1, wherein the carboxylic ester (C) is at least one compound selected from the group consisting of gamma-butyrolactone and a derivative of gamma-butyrolactone.

7: The lithium-ion capacitor according to claim 2, wherein the cyclic carbonate ester (B) is a compound represented by a general formula (2), 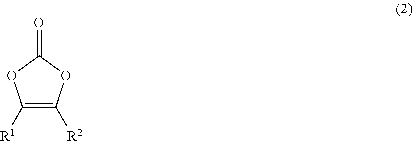
wherein R¹ and R² are independently a hydrogen atom, a halogen atom, an alkyl group having 1 to 6 carbon atoms, an alkenyl group having 1 to 6 carbon atoms, or a phenyl group.

8: The lithium-ion capacitor according to claim 2, wherein the cyclic carbonate ester (B) is at least one compound selected from the group consisting of vinylene carbonate, vinyl ethylene carbonate, divinyl ethylene carbonate, and fluorovinylene carbonate.

9: The lithium-ion capacitor according to claim 2, wherein the carboxylic ester (C) is a compound represented by a general formula (3), 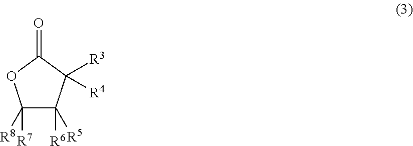
wherein R³ to R⁸ are independently a hydrogen atom, a halogen atom, an alkyl group having 1 to 6 carbon atoms, or an acetyl group.

10: The lithium-ion capacitor according to claim 3, wherein the carboxylic ester (C) is a compound represented by a general formula (3), 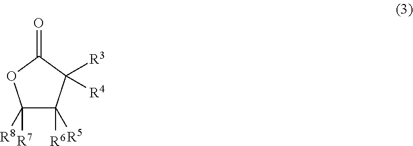
wherein R³ to R⁸ are independently a hydrogen atom, a halogen atom, an alkyl group having 1 to 6 carbon atoms, or an acetyl group.

11: The lithium-ion capacitor according to claim 4, wherein the carboxylic ester (C) is a compound represented by a general formula (3), 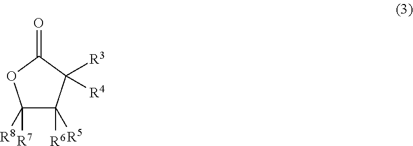
wherein R³ to R⁸ are independently a hydrogen atom, a halogen atom, an alkyl group having 1 to 6 carbon atoms, or an acetyl group.

12: The lithium-ion capacitor according to claim 7, wherein the carboxylic ester (C) is a compound represented by a general formula (3), 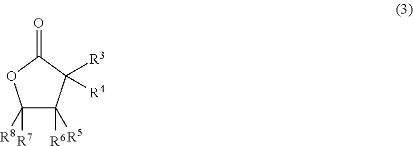
wherein R³ to R⁸ are independently a hydrogen atom, a halogen atom, an alkyl group having 1 to 6 carbon atoms, or an acetyl group.

13: The lithium-ion capacitor according to claim 8, wherein the carboxylic ester (C) is a compound represented by a general formula (3), 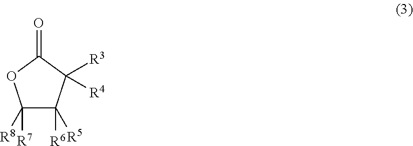
wherein R³ to R⁸ are independently a hydrogen atom, a halogen atom, an alkyl group having 1 to 6 carbon atoms, or an acetyl group.

14: The lithium-ion capacitor according to claim 2, wherein the carboxylic ester (C) is at least one compound selected from the group consisting of gamma-butyrolactone and a derivative of gamma-butyrolactone.

15: The lithium-ion capacitor according to claim 3, wherein the carboxylic ester (C) is at least one compound selected from the group consisting of gamma-butyrolactone and a derivative of gamma-butyrolactone.

16: The lithium-ion capacitor according to claim 4, wherein the carboxylic ester (C) is at least one compound selected from the group consisting of gamma-butyrolactone and a derivative of gamma-butyrolactone.

17: The lithium-ion capacitor according to claim 7, wherein the carboxylic ester (C) is at least one compound selected from the group consisting of gamma-butyrolactone and a derivative of gamma-butyrolactone.

18: The lithium-ion capacitor according to claim 8, wherein the carboxylic ester (C) is at least one compound selected from the group consisting of gamma-butyrolactone and a derivative of gamma-butyrolactone.
